(19) United States
(12) Patent Application Publication
(10) Pub. No.: US 2015/0363319 A1
(43) Pub. Date: Dec. 17, 2015

(54) FAST WARM-UP OF HOST FLASH CACHE AFTER NODE FAILOVER

(71) Applicant: NetApp, Inc., Sunnyvale, CA (US)

(72) Inventors: Yanling Qi, Austin, TX (US); Brian McKean, Boulder, CO (US); Somasundaram Krishnasamy, Austin, TX (US); Dennis Hahn, Wichita, KS (US)

(21) Appl. No.: 14/302,863

(22) Filed: Jun. 12, 2014

(51) Int. Cl. G06F 12/08; G06F 3/06

(52) U.S. Cl. CPC G06F 12/0868; G06F 12/0813; G06F 3/0619; G06F 3/067; G06F 3/065; G06F 2212/314; G06F 2212/604

(57) ABSTRACT

Examples described herein include a system for storing data. The data storage system retrieves a first set of metadata associated with data stored on a first cache memory, and stores the first set of metadata on a primary storage device. The primary storage device is a backing store for the data stored on the first cache memory. The storage system selectively copies data form the primary storage device to a second cache memory based, at least in part, on the first set of metadata stored on the primary storage device. For some aspects, the storage system may copy the data from the primary storage device to the second cache memory upon determining that the first cache memory is in a failover state.

### TECHNICAL FIELD

Examples described herein relate to computer storage networks, and more specifically, to a system and method for reducing the warm-up time of a host flash cache in the event of a node failover.

### BACKGROUND

Data storage technology over the years has evolved from a direct attached storage model (DAS) to using remote computer storage models, such as Network Attached Storage (NAS) and Storage Area Network (SAN). With the direct storage model, the storage is directly attached to the workstations and applications servers, but this creates numerous difficulties with administration, backup, compliance, and maintenance of the directly stored data. These difficulties are alleviated at least in part by separating the application server/workstations form the storage medium, for example, using a computer storage network.

A typical NAS system includes a number of networked servers (e.g., nodes) for storing client data and/or other resources. The servers may be accessed by client devices (e.g., personal computing devices, workstations, and/or application servers) via a network such as, for example, the Internet. Specifically, each client device may issue data access requests (e.g., corresponding to read and/or write operations) to one or more of the servers through a network of routers and/or switches. Typically, a client device uses an IP-based network protocol, such as Common Internet File System (CIFS) and/or Network File System (NFS), to read from and/or write to the servers in a NAS system.

Conventional NAS servers include a number of data storage hardware components (e.g., hard disk drives, processors for controlling access to the disk drives, I/O controllers, and high speed cache memory) as well as an operating system and other software that provides data storage and access functions. Frequently-accessed (“hot”) application data may be stored on the high speed cache memory of a server node to facilitate faster access to such data. The process of determining which application data is hot and copying that data from a primary storage array into cache memory is called a cache “warm-up” process. However, when a particular node is rendered unusable, and/or is no longer able to service data access requests, it may pass on its data management responsibilities to another node in a node cluster (e.g., referred to as “node failover”). In conventional implementations, the new node subsequently warms up its cache with no prior knowledge as to which application data is hot.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

A computer system performs operations that include retrieving a first set of metadata associated with data stored on a first cache memory and storing the first set of metadata on a primary storage device. Specifically, the primary storage device serves as a backing store for the data stored on the first cache memory. Data stored on the primary storage device may then be copied to a second cache memory based, at least in part, on the first set of metadata stored on the primary storage device.

In an aspect, the computer system may determine that the first cache memory is in a failover state. For example, a failover state may occur when a server node (e.g., on which the first cache memory resides) is rendered nonfunctional and/or otherwise unable to service data access requests. Thus, while in the failover state, data stored on the first cache memory may be inaccessible and/or unavailable. In some aspects, the computer system may copy the data form the primary storage device to the second cache memory upon determining that the first cache memory is in the failover state.

In another aspect, the computer system may retrieve a second set of metadata associated with the data stored on the first cache memory, and store the second set of metadata on the primary storage device. For example, the first set of metadata may correspond with a first application state of the data stored on the first cache memory, whereas the second set of metadata may correspond with a second application state of the data stored on the first cache memory. A first label may be assigned to the first set of metadata based, at least in part, on a time at which the first set of metadata is retrieved from the first cache memory. Further, a second label may be assigned to the second set of metadata based, at least in part, on a time at which the second set of metadata is retrieved from the first cache memory. In some aspects, the computer system may select one of the first or second sets of metadata based on the first and second labels. Data associated with the selected set of metadata may then be copied from the primary storage device to the second cache memory.

In yet another aspect, the computer system may determine one or more temperature values for the first set of metadata. For example, the one or more temperature values may correspond with a number of cache hits for the data associated with the first set of metadata. The one or more temperature values may then be stored with the first set of metadata on the primary storage device. In some aspects, the computer system may copy the data from the primary storage device to the second cache memory based, at least in part, on the one or more temperature values associated with the first set of metadata. For example, caching data associated with warmer temperature values may take precedence over caching data associated with colder temperature values.

Aspects described herein recognize that cache metadata (e.g., metadata associated with application data stored in cache memory) may provide a reliable indicator of which application data is hot at any given time. By backing up the cache metadata on a primary storage device, a new node may quickly warm up its local cache memory using the cache metadata in the event of a node failover. Furthermore, by storing multiple versions of cache metadata, the new node may warm up its cache memory to any desired application state.

### BRIEF DESCRIPTION OF THE DRAWINGS

FIGS. 1A and 1B illustrate a data storage system capable of fast cache warm-up, in accordance with some aspects.

FIG. 2 illustrates a server node with cache metadata synchronization functionality, in accordance with some aspects.

FIG. 3 illustrates a method for synchronizing data across multiple cache memory devices, in accordance with some aspects.

FIG. 4 illustrates a method for backing up cache metadata to a primary storage device, in accordance with some aspects.

FIG. 5 illustrates a method for warming up a cache memory using cache metadata, in accordance with some aspects.

FIG. 6 illustrates a method for registering cache metadata on a primary storage device, in accordance with some aspects.

FIG. 7 is a block diagram that illustrates a computer system upon which aspects described herein may be implemented.

### DETAILED DESCRIPTION

Examples described herein include a computer system to reduce the warm-up time of a host flash cache in the event of a node failover. In particular, the examples herein provide for a method of synchronizing data across multiple cache memory devices using cache metadata. In some aspects, the cache metadata is backed up on a primary storage device so that it may be accessed by any node in a node cluster in the event of a cache memory failure.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more aspects described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist in a hardware component independently of other modules/components or a module/component can be a shared element or process of other modules/components, programs or machines. A module or component may reside on one machine, such as on a client or on a server, or may alternatively be distributed among multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system may use memory, processors and network resources (including data ports and signal lines (optical, electrical etc.)), unless stated otherwise.

Furthermore, one or more aspects described herein may be implemented through the use of instructions that are executable by one or more processors. These instructions may be carried on a non-transitory computer-readable medium. Machines shown in figures below provide examples of processing resources and non-transitory computer-readable mediums on which instructions for implementing one or more aspects can be executed and/or carried. For example, a machine shown for one or more aspects includes processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and tablets) and magnetic memory. Computers, terminals, and network-enabled devices (e.g. portable devices such as cell phones) are all examples of machines and devices that use processors, memory, and instructions stored on computer-readable mediums.

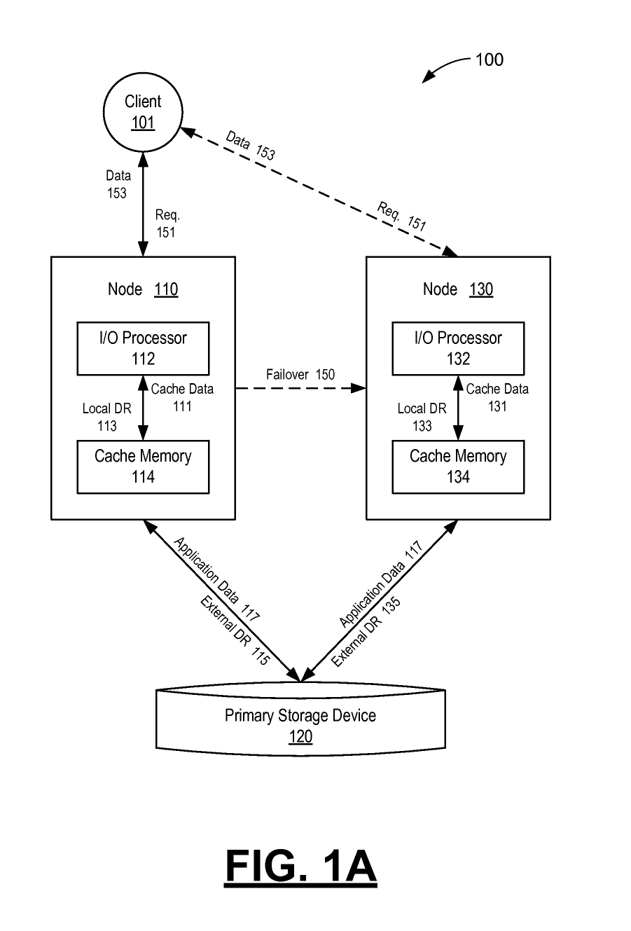

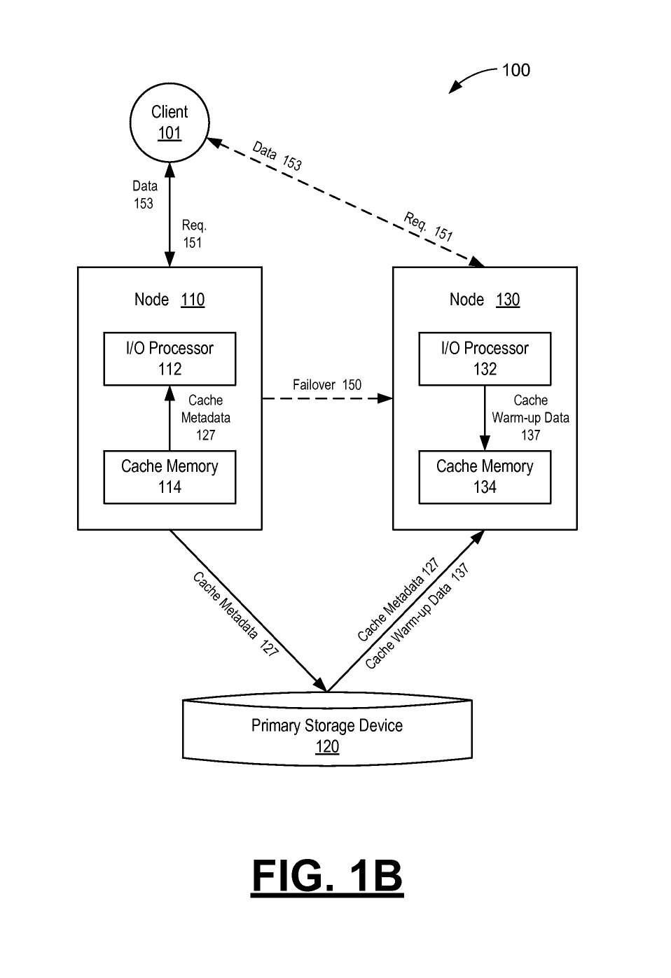

FIG. 1A illustrates a data storage system 100 capable of fast cache warm-up, in accordance with some aspects. The system 100 includes a host node 110 coupled to a primary storage device 120 and a backup node 130. The host node 110 may correspond to a server on a network that is configured to provide access to the primary storage device 120. It should be noted that the data storage system 100 may include fewer or more nodes and/or data stores than those shown. For example, node 110 may belong to a multi-node cluster that is interconnected via a switching fabric. A client terminal 101 may send data access requests 151 to and/or receive data 153 from the host node 110. More specifically, the host node 110 (and backup node 130) may run application servers such as, for example, a Common Internet File System (CIFS) server, a Network File System (NFS) server, a database server, a web server, and/or any other application server. Each data access request 151 corresponds to a read or write operation to be performed on a particular data volume or storage drive in the primary storage device 120. It should be noted that data access requests may also originate from the host node 110 (and/or backup node 130) for maintenance purposes (e.g., data mining, generating daily reports, data indexing, data searching, etc.).

For example, the host node 110 may store write data in the primary storage device 120, in response to a data request 151 specifying a write operation. The host node 110 may also retrieve read data from the primary storage device 120, in response to a data request 151 specifying a read operation. The primary storage device 120 may include a number of mass storage devices (e.g., disk drives or storage drives). For example, data may be stored on conventional magnetic disks (e.g., HDD), optical disks (e.g., CD-ROM, DVD, Blu-Ray, etc.), magneto-optical (MO) storage, and/or any other type of volatile or non-volatile medium suitable for storing large quantities of data.

Node 110 further includes an input and output (I/O) processor 112 coupled to a cache memory 114. For some aspects, the cache memory 114 may allow for faster data access than the primary storage device 120. For example, the cache memory may be implemented as a flash memory device or solid state drive (SSD). For other aspects, the cache memory 114 may correspond to any form of data storage device (e.g., EPROM, EEPROM, HDD, etc.). To improve the data response times of the node 110, the cache memory 114 may be loaded with frequently-accessed application data from the primary storage device 120. The process of loading the cache memory 114 with frequently-accessed data is called cache “warm-up.” Thus, upon receiving a data access request 151 from the client terminal 101, the I/O processor 112 may first attempt to perform the corresponding read and/or write operations on the cache memory 114 before accessing the primary storage device 120.

For example, in response to a read data request, the I/O processor 112 may first output a local data request (DR) 113 to the cache memory 114 to retrieve the corresponding data. A “cache hit” condition occurs if the requested data is available in the cache memory 114, and corresponding cache data 111 is subsequently returned to the I/O processor 112. On the other hand, a “cache miss” condition occurs if the requested data is not stored in the cache memory 114. In the event of a cache miss, the I/O processor 112 may then output an external DR 115 to the primary storage device 120 to retrieve application data 117. It should be noted that any data stored in the cache memory 114 can also be found in the primary storage device 120. Accordingly, the primary storage device 120 may be referred to as a “backing store” for the data in the cache memory 114. However, due to differences in hardware and/or the amount of stored data, the primary storage device 120 may service data requests at a much slower rate than the cache memory 114.

In some instances, the host node 110 may transfer its data management services to the backup node 130. For example, the host node 110 may need to transfer its services if the I/O processor 112 fails and/or is unable to process data access requests 151 received from the client terminal 101. The service handoff between the host node 110 and the backup node 130 may be referred to as a “node failover.” For example, a node failover may be triggered when the host node 110 (or a cluster management controller) outputs a failover signal 150 to the backup node 130. Upon receiving the failover signal 150, the backup node 130 may begin servicing the data access requests 151 from the client terminal 101.

The backup node 130 includes an I/O processor 132 and a cache memory 134 for storing frequently-accessed application data. However, it should be noted that immediately following a node failover, the cache memory 134 may not contain any application data from the primary storage device 120. Thus, the backup node 130 may subsequently warm-up its cache memory 134. Under conventional implementations, a server node may monitor data access requests over a period of time to determine which application data is “hottest” (e.g., most frequently requested) and should therefore be stored in cache memory. How, this method of populating a cache memory from scratch is often slow and inefficient.

Aspects herein recognize that the data stored in the cache memory 114 of the original host node 110 may be a good indicator of the application data most frequently accessed by the client terminal 101. Specifically, for some aspects, the backup node 130 may warm up its cache memory 134 based on cache metadata derived from the original host node 110. For example, as shown in FIG. 1B, the I/O processor 112 may retrieve cache metadata 127 from the cache memory 114 while the host node 110 still acts as the primary host node for the client terminal 101 (e.g., prior to a node failover). The cache metadata 127 may include any and/or all metadata (e.g., data owner, storage time/date, storage location, file size, data type, checksum, inode, context information, volume identifier, logical block address, data length, data temperature or priority, etc.) associated with the application data stored in the cache memory 114 at a given time. More specifically, the cache metadata 127 may include any information that may be used to uniquely identify and/or distinguish the data stored in the cache memory 114 from other application data stored on the primary storage device 120. For some aspects, the cache metadata 127 may reflect an application state of the data stored in the cache memory 114 at a particular time. Further, for some aspects, the I/O processor 112 may periodically retrieve the cache metadata 127 from the cache memory 114. Alternatively, and/or additionally, the I/O processor 112 may retrieve the cache metadata 127 in response to a user request (e.g., initiated by the client terminal 101).

The host node 110 may further store the cache metadata 127 on the primary storage device 120. Thus, when the host node 110 sends a failover signal 150 to the backup node 130, the backup node 130 may retrieve the cache metadata 127 from the primary storage device 120 and reconstruct the data previously stored on the cache memory 114 based on the cache metadata 127. For example, the I/O processor 132 may determine which application data is associated with the cache metadata 127. The I/O processor 132 may then fetch the corresponding application data (e.g., as cache warm-up data 137) from the primary storage device 120 and load the cache warm-up data 137 into the cache memory 134. Once the cache warm-up data 137 is loaded into the cache memory 134, the backup node 130 may immediately begin servicing data access requests 151 using the cache memory 134. Moreover, because the cache warm-up data 137 reflects recently-stored data in the cache memory 114, there is a high probability that local data requests 133 to the cache memory 134 will result in cache hits.

The cache metadata 127 stored on the primary storage device 120 enables the backup node 130 to quickly warm-up its cache memory 134 in the event of a node failover. It should be noted however, that the frequency with which the host node 110 backs up cache metadata 127 on the primary storage device 120 may have a direct effect on the efficiency or accuracy of the cache memory 134 upon warming up. For example, increasing the frequency with which the host node 110 backs up cache metadata 127 also increases the likelihood that the cache warm-up data 137 retrieved by the backup node 120 will reflect the latest application state of the data stored on the cache memory 114. For some aspects, the backup node 130 may monitor the cache metadata 127 stored on the primary data store 120 prior to receiving a failover signal 150 from the host node 110. For example, this may allow even faster cache warm-up if and when a node failover occurs.

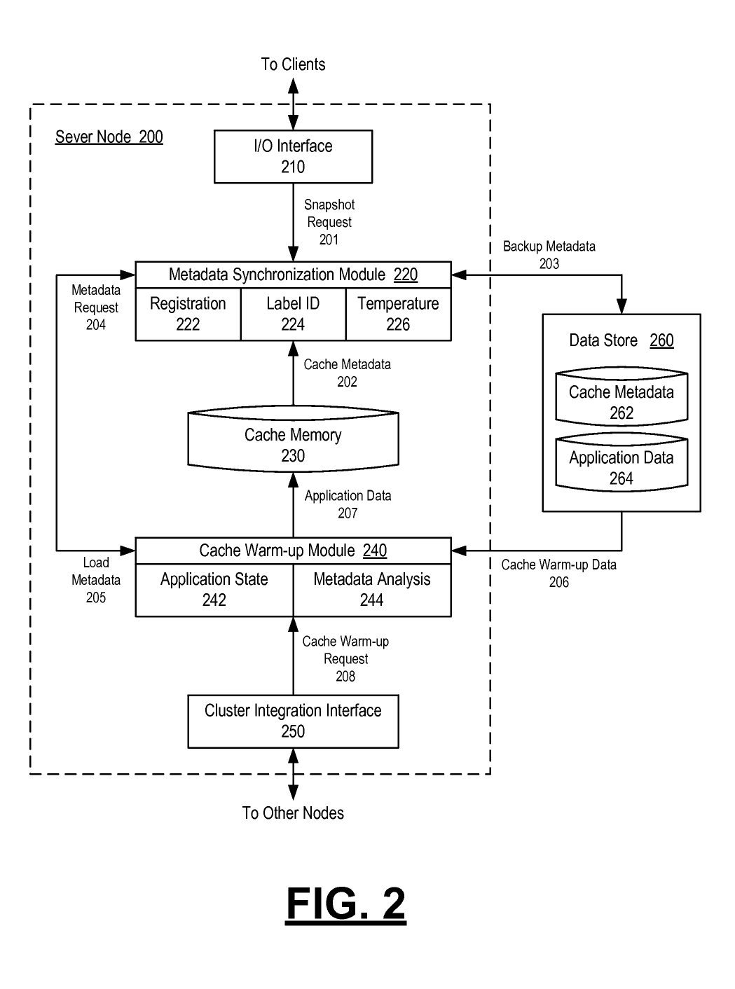

FIG. 2 illustrates a server node 200 with cache metadata synchronization functionality, in accordance with some aspects. With reference, for example, to FIGS. 1A and 1B, the server node 200 may be implemented as any of the nodes 110 and/or 130 of storage system 100. Server node 200 may be a server on a network that is configured to provide access to a data store 260. The data store 260 may correspond to a storage subsystem, for example, such as a storage area network (SAN) attached storage array or network attached storage. The data store 260 includes a partition 262 for storing cache metadata and another partition 264 for storing application data. For some aspects, each partition 262 and 264 may correspond to a physical storage drive (e.g., disk). Each storage drive may be, for example, a conventional magnetic disk (e.g., HDD), an optical disk (e.g., CD-ROM, DVD, Blu-Ray, etc.), a magneto-optical (MO) drive, and/or any other type of volatile or non-volatile medium suitable for storing large quantities of data. Alternatively, the partitions 262 and 264 may represent virtual partitions of the same physical hard drive.

As described above, the data store 260 serves as a backing store for the data stored in a cache memory 230 of the server node 200. More specifically, the application data partition 264 may contain a copy of any data stored in the cache memory 230. However, due to differences in hardware and/or the amount of stored data, the data store 260 may service data requests at a much slower rate than the cache memory 230.

The server node 200 includes an I/O interface 210, a metadata synchronization module 220, cache memory 230, a cache warm-up module 240, and a cluster integration interface 250. The I/O interface 210 facilitates communications between the server node 200 and one or more client terminals (not shown). Specifically, the I/O interface 210 may receive data access requests specifying read and/or write operations to be performed on the data store 260 (and/or the cache memory 230). For example, the I/O interface 210 may support network-based protocols such as CIFS and/or NFS. In some instances, the I/O interface 201 may further receive snapshot requests 201 from one or more client terminals. As described in greater detail below, each snapshot request 201 may correspond with a user-initiated backup of cache metadata (e.g., to back up a current state or “snapshot” of the data on the cache memory 230).

The metadata synchronization module 220 retrieves cache metadata 202 from the cache memory 230 and stores corresponding backup metadata 203 on the data store 260 (e.g., in the cache metadata partition 262). As described above, the cache metadata 202 may include any and/or all metadata (e.g., data owner, storage time/date, storage location, file size, data type, checksum, inode, context information, etc.) associated with the data stored in the cache memory 230. More specifically, the cache metadata 202 may include information that may be used to uniquely identify and/or distinguish data stored in the cache memory 230 from other application data stored in the data store 260. For some aspects, the cache metadata 202 may reflect an application state of the data stored in the cache memory 230 at a particular time (e.g., when the cache metadata 202 is retrieved metadata synchronization module 220).

For some aspects, the metadata synchronization module 220 may periodically retrieve cache metadata 202 from the cache memory 230 (e.g., at predetermined time intervals). For other aspects, the cache metadata 202 may be retrieved according to a time-invariant schedule (e.g., based on a particular application state). Still further, for some aspects, the metadata synchronization module 220 may retrieve cache metadata 202 in response to snapshot requests 201 from a user. For example, the user may send a snapshot request 201 to the server node 200 (e.g., via the I/O interface 210) in order to save a current application state of the data stored on the cache memory 230. More specifically, the snapshot request 201 may allow the user to restore or recreate the saved application state on the cache memory 230 at a later time (e.g., based on the cache metadata 202).

The metadata synchronization module 220 may include a registration sub-module 222, a label ID generator 224, and a temperature evaluator 226. The registration sub-module 222 may register the server node 200 as the owner of a particular set of cache metadata stored in the data store 260. For example, the registration sub-module 222 may retrieve ownership information from the data store 260 to determine the current and/or previous owner of the metadata stored in the cache metadata partition 262. For some aspects, the registration sub-module 222 may register ownership of the cache metadata stored in the cache metadata partition 262 if there is no previously- or currently-registered owner. For other aspects, the registration sub-module 222 may force a takeover of the cache metadata stored in the cache metadata partition 262, even if there is another registered owner, as long as the server node 200 is the resource owner of the logical unit (LUN) in which the cache metadata partition 262 resides.

The label ID generator 224 may assign a label to the cache metadata 202 retrieved by the metadata synchronization module 220. The label may be used to identify and/or distinguish each set of cache metadata 202 based, at least in part, on the time in which that particular set of cache metadata 202 is retrieved from the cache memory 230. For example, the cache metadata 202 retrieved at a first time (t₁) may be different than the cache metadata 202 retrieved at a later time (t₂). More specifically, the cache metadata 202 retrieved at time t₁ may reflect a different application state of the data stored in the cache memory 230 than the cache metadata 202 retrieved at time t₂. The metadata synchronization module 220 may store the label together with the corresponding cache metadata 202 (e.g., as backup metadata 203) in the cache metadata partition 262 of the data store 260. Thus, for some aspects, the data store 260 may store multiple sets of cache metadata 202 (e.g., for multiple application states). For other aspects, the data store 260 may store only the most recent set of cache metadata 202 retrieved from the cache memory 230.

The temperature evaluator 226 may determine a temperature value for the cache metadata 202 retrieved by the metadata synchronization module 220. More specifically, the temperature value may indicate whether a data chunk associated with a particular set of cache metadata 202 is “hot” or “cold.” For example, a data chunk may be considered hot if the server node 200 receives a high volume of data requests for that particular chunk during a given time period. On the other hand, a data chunk may be considered cold if the server node 200 receives a low volume of data requests for that particular chunk during a given time period. For some aspects, the temperature evaluator 226 may assign a temperature value to the set of cache metadata 202 as a whole. For other aspects, the temperature evaluator 226 may assign a temperature value to individual items of metadata within the set 202. For example, at any given time, some data in the cache memory 230 may be hotter than other data stored therein. Accordingly, the temperature evaluator 226 may assign temperature values with finer granularity to account for such discrepancies in hotness among cache data. Further, for some aspects, each temperature value may indicate a degree of hotness or coldness (e.g., based on the percentage of cache hits to cache misses for a given time period).

The metadata synchronization module 220 may then store the temperature value together with the corresponding cache metadata 202 (e.g., as backup metadata 203) in the cache metadata partition 262 of the data store 260. For some aspects, the metadata synchronization module 220 may determine whether or not to store a particular set of cache metadata 202 in the data store 260 based on its corresponding temperature value. For example, a cold (or colder) temperature value may indicate that the cache memory 230 is not very effective in its current state (e.g., resulting in too many cache misses). Accordingly, it may be undesirable to store the cache metadata 202 associated with such an application state. Thus, for some aspects, the metadata synchronization module 220 may selectively store cache metadata 202 on the data store 260 based on whether the temperature value associated therewith is at or above a predetermined temperature threshold. For example, the metadata synchronization module 220 may store the cache metadata 202 on the data store 260 only if its temperature value satisfies a certain degree of hotness.

The cache warm-up module 240 may be used to warm up the cache memory 230 based on cache metadata stored in the data store 260.

More specifically, the cache warm-up module 240 may be responsive to a cache warm-up request 208 received via the cluster integration interface 250. The cluster integration interface 250 facilitates communications between multiple nodes of a node cluster. For example, the cluster integration interface 250 may receive a failover signal from another node, in the event that the other node is no longer able to service data requests and/or provide access to the data store 260. Upon receiving the failover signal, the cluster integration interface 250 may output the cache warm-up request 208 to the cache warm-up module 240.

Upon receiving the cache warm-up request 208, the cache warm-up module 240 may send a metadata request 204 to the metadata synchronization module 220 requesting a set of cache metadata stored on the data store 260. For some aspects, the cache warm-up module 240 may request cache metadata having a particular degree of hotness (e.g., based on a corresponding temperature values). For example, the cache warm-up module 240 may request only cache metadata having temperature values at or above a predetermined temperature threshold. Alternatively, the cache warm-up module 240 may prioritize the retrieval of cache metadata based on associated temperature values. For example, the cache warm-up module 240 may request cache metadata having hotter temperature values before requesting cache metadata having colder temperature values.

The cache warm-up module 240 may further include an application state evaluator 242 and a metadata analysis sub-module 244. More specifically, the application state evaluator 242 may determine an application state to which the cache memory 230 is to be warmed up (e.g., based on the current time, date, and/or received data requests). For some aspects, the cache warm-up module 240 may specifically request cache metadata associated with the application state determined by the application state evaluator 242. For other aspects, the cache warm-up module 240 may simply request the most recently stored cache metadata in the data store 260.

The metadata synchronization module 220 retrieves a set of backup metadata 203 from the data store 260 (e.g., from the cache metadata partition 262) based on the metadata request 204, and returns the backup metadata 203 (e.g., as load metadata 205) to the cache warm-up module 240. For example, the metadata synchronization module 220 may determine a label associated with the requested application state and retrieve the backup metadata 203 having the corresponding label. Alternatively, and/or additionally, the metadata synchronization module 220 may selectively retrieve backup metadata 203 from the data store 260 only if such backup metadata 203 has a temperature value that satisfies the requested temperature criteria.

The metadata analysis sub-module 244 determines a set of application data associated with the load metadata 205 returned by the metadata synchronization module 220. For example, the metadata analysis sub-module 244 may analyze the information contained in the load metadata 205 to determine which application data (e.g., stored in the application data partition 264 of the data store 260) is identified by that information. The cache warm-up module 240 may then retrieve the identified application data (e.g., as cache warm-up data 206) from the application data partition 264 of the data store 260 and store the corresponding application data 207 in the cache memory 230.

For some aspects, the cache warm-up data 206 may correspond with the most recent cache data stored on a previous host node. For other aspects, the cache warm-up data 206 may correspond with a particular application state of the cache data on the previous host node (e.g., a snapshot of the cache data at a particular time). Therefore, the cache warm-up module 240 may allow the server node 200 to quickly warm up its cache memory 230 (e.g., prior to the server node 200 receiving any data access requests).

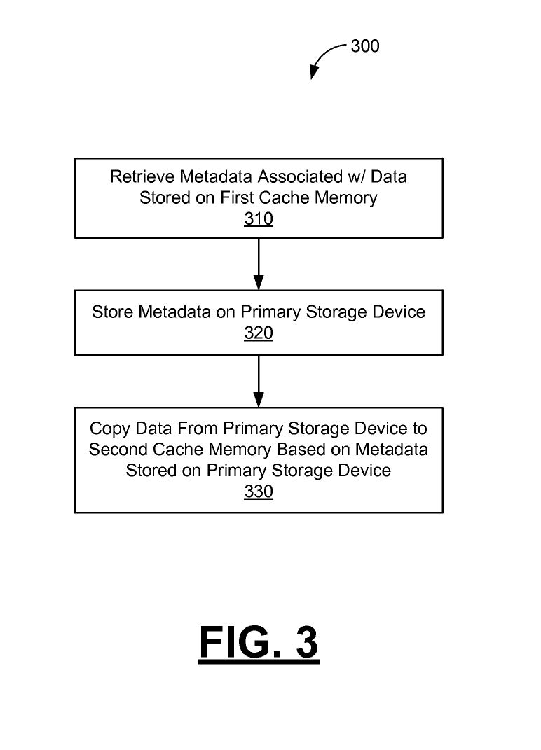

FIG. 3 illustrates a method 300 for synchronizing data across multiple cache memory devices, in accordance with some aspects. The method 300 may be implemented, for example, by the data storage system 100 described above with respect to FIGS. 1A-1B. Specifically, the method 300 is initiated upon retrieval of metadata associated with data stored on a first cache memory (310). For example, the I/O processor 112 may retrieve cache metadata 127 from the cache memory 114 while the host node 110 serves as an intermediary between the client terminal 101 and the primary storage device 120. As described above, the cache metadata 127 may include any information that may be used to uniquely identify and/or distinguish the data stored in the cache memory 114 from other application data stored on the primary storage device 120. For some aspects, the cache metadata 127 may reflect an application state of the data stored in the cache memory 114 at a particular time.

The retrieved metadata is further stored on a primary storage device (320). For example, the node 110 may write the cache metadata 127 to the primary storage device 120, on which other application data is stored. The primary storage device 120 may correspond to a backing store for the data stored in the cache memory 114. More specifically, the primary storage device 120 may contain a copy of any data stored in the cache memory 114. However, due to differences in hardware and/or the amount of data stored, the primary storage device 120 may service data requests at a much slower rate than the cache memory 114.

Data is then copied from the primary storage device to a second cache memory based on the metadata stored on the primary storage device (330). For example, the backup node 130 may retrieve the cache metadata 127 from the primary storage device 120 and reconstruct the data previously stored on the cache memory 114 based on the cache metadata 127. More specifically, the I/O processor 132 may determine which application data is associated with the cache metadata 127. The backup node 130 may then fetch the corresponding cache warm-up data 137 from the primary storage device 120 and store the data 137 in its cache memory 134. Upon storing the cache warm-up data 137, the cache memory 134 is effectively warmed up.

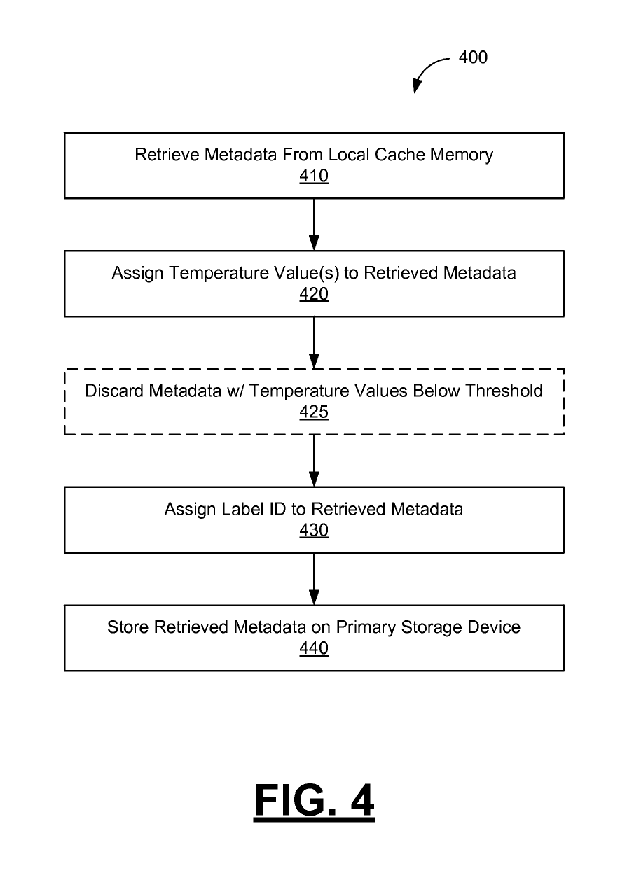

FIG. 4 illustrates a method 400 for backing up cache metadata to a primary storage device, in accordance with some aspects. The method 400 may be implemented, for example, by the server node 200 described above with respect to FIG. 2. Specifically, the server node 200 may first retrieve metadata from a local cache memory (410). For example, the metadata synchronization module 220 may retrieve cache metadata 202 from the cache memory 230. As described above, the cache metadata 202 may include information that uniquely identifies and/or distinguishes data stored in the cache memory 230 from other application data stored in the data store 260. For some aspects, the cache metadata 202 may reflect an application state of the data stored in the cache memory 230 at a particular time.

The server node 200 further assigns one or more temperature values to the retrieved metadata (420). For example, the temperature evaluator 226 may determine a temperature value for the cache metadata 202 based on whether the data associated with the cache metadata 202 is hot or cold, for example, based on a number of cache hits and/or cache misses associated with the data stored in the cache memory 230 (e.g., for a given time period). For some aspects, the temperature evaluator 226 may assign a temperature value to the set of cache metadata 202 as a whole. For other aspects, the temperature evaluator 226 may assign a temperature value to individual items of metadata within the set 202. The temperature value may further indicate a degree of hotness or coldness, for example, based on the percentage of cache hits to cache misses for a given time period.

For some aspects, the server node 200 may discard any metadata with a temperature value below a threshold temperature (425). For example, the metadata synchronization module 220 may filter the cache metadata 202 based on whether the temperature value associated therewith is at or above a predetermined temperature threshold. More specifically, the metadata synchronization module 220 may selectively discard the retrieved cache metadata 202 if the application data associated with that metadata does not satisfy a certain degree of hotness.

The server node 200 may then assign a label ID to the retrieved metadata (430). For example, the label ID generator 224 may assign a label to each set of cache metadata 202 retrieved from the cache memory 230 based, at least in part, on the time at which that particular set of cache metadata 202 is retrieved from the cache memory 230. For some aspects, the label may be used to identify a particular application state of the data stored in the cache memory 230 at the time the cache metadata 202 is retrieved. Accordingly, the label may be used to distinguish different sets of cache metadata 202 from one another, for example, allowing the data store 260 to store multiple sets of cache metadata 202 concurrently.

Finally, the server node 200 stores the retrieved metadata on a primary storage device (440). For example, the metadata synchronization module 220 may store the cache metadata 202 (e.g., as backup metadata 203) in the cache metadata partition 262 of the data store 260. As described above, the data store 260 may correspond to a backing store for the data stored in the cache memory 230. For some aspects, the set of cache metadata 202 may be stored together with a corresponding label (e.g., as determined by the label ID generator 224). For example, the metadata synchronization module 220 may store multiple sets of cache metadata 202 each identified by a corresponding label. Further, for some aspects, the set of cache metadata 202 may be stored together with one or more corresponding temperature values (e.g., as determined by the temperature evaluator 226). For example, the metadata synchronization module 220 may store only the cache metadata 202 having temperature values at or above a predetermined temperature threshold.

It should be noted that the method 400 of backing up cache metadata to a primary storage device may be performed periodically and/or according to a time-invariant schedule. For example, the metadata synchronization module 220 may retrieve cache metadata 202 from the cache memory 230 at predetermined time intervals. Alternatively, and/or additionally, the metadata synchronization module 220 may retrieve cache metadata 202 based on a particular application state of the data stored on the cache memory 230. Still further, the method 400 may be manually invoked. For example, the metadata synchronization module 220 may retrieve cache metadata 202 in response to a snapshot request 201 from a user.

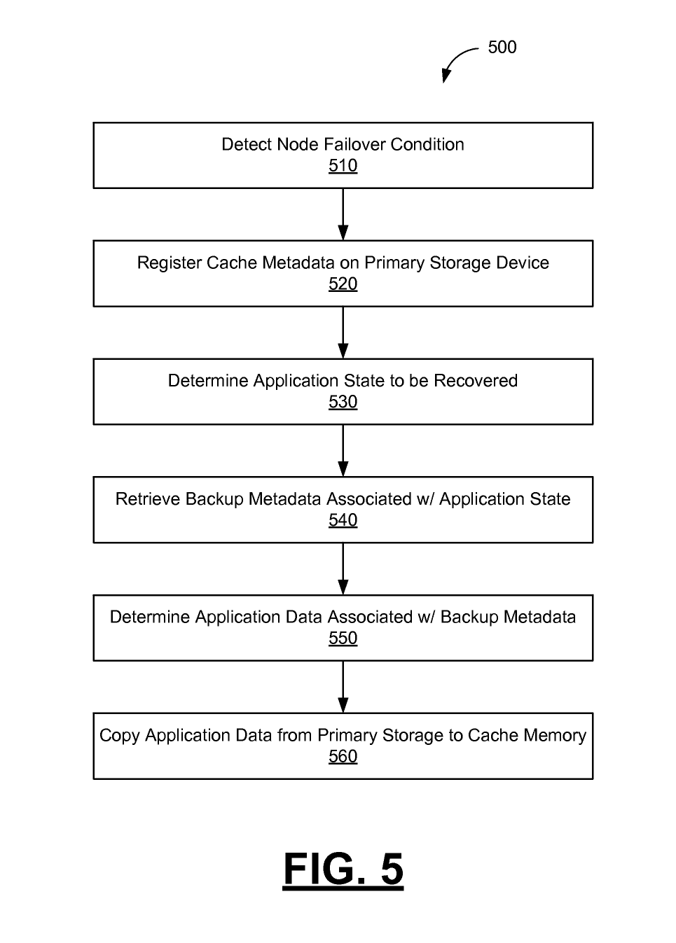

FIG. 5 illustrates a method 500 for warming up a cache memory using cache metadata, in accordance with some aspects. The method 500 may be implemented, for example, by the server node 220 described above with respect to FIG. 2. Specifically, the method 500 may be invoked when the server node 200 detects a node failover condition (510). For example, the cluster integration interface 250 may receive a failover signal from another node, in the event that the other node is no longer able to service data requests and/or provide access to the data store 260.

Upon detecting a node failover condition, the server node 200 may register cache metadata on a primary storage device (520). For example, the registration sub-module 222 may register the server node 200 as the owner of the cache metadata stored in the cache metadata partition 262 of the data store 260. More specifically, the registration sub-module 222 may retrieve ownership information from the data store 260 to determine the current and/or previous owner of the cache metadata stored in the cache metadata partition 262. For some aspects, the registration sub-module 22 may register ownership of the cache metadata stored in the cache metadata partition 262 if there is no previously- or currently-registered owner. For other aspects, the registration sub-module 222 may force a takeover of the cache metadata stored in the cache metadata partition 262 if the server node 200 is the resource owner of the LUN in which the cache metadata partition 262 resides.

The server node 200 then determines an application state to be recovered (530). For example, the application state evaluator 242 may determine an application state to which the cache memory 230 is to be warmed up (e.g., based on the current time, date, and/or received data requests). Alternatively, the application state evaluator 242 may simply determine that the cache memory 230 should be warmed up to the last known application state of a corresponding cache memory on the previous host node.

Next, the server node 200 retrieves backup metadata associated with the desired application state (540). For example, the cache warm-up module 240 may specifically request cache metadata associated with the application state determined by the application state evaluator 242. Alternatively, the cache warm-up module 240 may simply request the most recently stored cache metadata in the data store 260. For some aspects, the cache warm-up module 240 may request only cache metadata having temperature values at or above a predetermined temperature threshold. For other aspects, the cache warm-up module 240 may prioritize the retrieval of cache metadata having hotter temperature values over cache metadata having colder temperature values. The metadata synchronization module 220 receives the metadata requests 204 from the cache warm-up module 240 and returns the requested backup metadata 203 (e.g., as load metadata 205) to the cache warm-up module 240.

Finally, the server node 200 determines a set of application data associated with the backup metadata (550) and copies the corresponding application data from the primary storage device to its cache memory (560). For example, the metadata analysis sub-module 244 may analyze the information contained in the load metadata 205 to determine which application data (e.g., stored in the application data partition 264 of the data store 260) is identified by that information. The cache warm-up module 240 may then retrieve the identified application data (e.g., as cache warm-up data 206) form the application data partition 264 of the data store 260 and store the corresponding application data 207 in the cache memory 230.

It should be noted that at least a portion of the method 500 (e.g., 530-560) may be performed prior to detecting a node failover condition. For example, in some aspects, the server node 200 may synchronize its local cache memory 230 with a corresponding cache memory of a host device even without detecting a node failover condition and/or registering ownership of the cache metadata stored on the data store 260. More specifically, synchronizing the cache memories of the host node and a backup node may allow for quicker cache warm-up in if and when a node failover does occur.

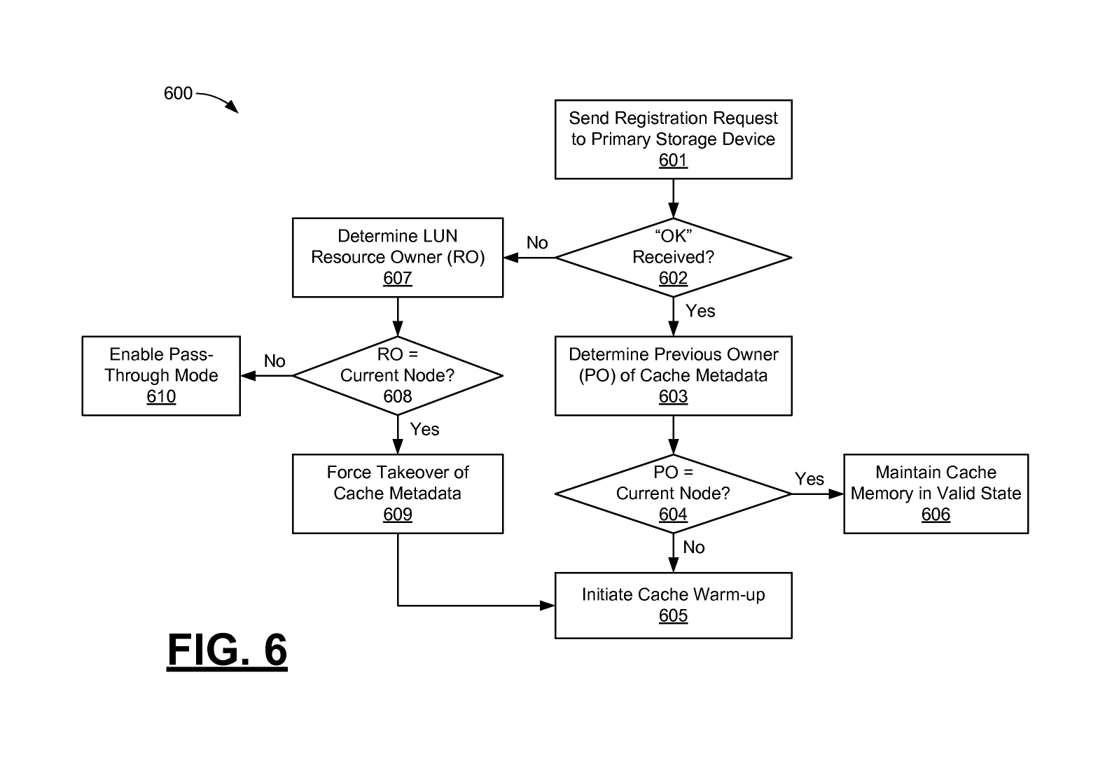

FIG. 6 illustrates a method 600 for registering cache metadata on a primary storage device, in accordance with some aspects. The method 600 may be implemented, for example, by the server node 200 described above with respect to FIG. 2. Specifically, the server node 200 may send a registration request to a primary storage device (601). For example, the registration sub-module 222 may notify the data store 260 that the server node 200 would like become the owner of the cache metadata stored in the cache metadata partition 262.

If the registration sub-module 222 receives an “OK” response from the data store 260 (602), it may proceed to determine the previous owner of the cache metadata (603). For example, the data store may return an OK response if: (i) no node is previously registered as the owner of the cache metadata; (ii) the current server node 200 is the previously registered owner of the cache metadata; and/or (iii) the cache metadata was previously owned by another node, but there is no current or effective owner of the cache metadata. the registration sub-module 222 may follow up by sending a cache metadata information request to the data store 260. In response to the information request, the data store may return a response message including a cache metadata owner identifier, a message generation number, and message timestamp.

If the server node 200 is the previous owner of the cache metadata (604), the server node 200 may continue to maintain its local cache memory in a valid state (606). For example, in some instances, the server node 200 (or an application thereon) may be shut down for maintenance. Since there is no node failover, when the server node 200 is brought back online it is both the current and previous owner of the cache metadata. Moreover, since the server node 200 is the previous owner of the cache metadata, then it is likely that the cache memory 230 is already synchronized with the data store 260 (e.g., the cache data stored in the cache memory 230 is still valid). In other words, the cache metadata in the cache metadata store 262 already reflects the data stored in the cache memory 230.

However, if the server node 200 is not the previous owner of the cache metadata (604), the server node 200 may proceed to warm up its local cache memory (605). For example, the registration sub-module 222 may register the server node 200 as the new owner of the cache metadata stored in the cache metadata partition 262 of the data store 260. The cache warm-up module 240 may then start the process of warming up the cache memory 230 (e.g., as described above with reference to FIG. 5).

If the server node 200 does not receive an “OK” message from the data store 260 in response to its registration request (602), it may then determine resource owner of the LUN on which the cache metadata is stored (607). For example, the data store 260 may reject the registration request by the registration sub-module 222 if the current owner of the cache metadata stored in the data store 260 is a node other than the current server node 200. Upon receiving a rejection from the data store 260, the registration sub-module 222 may request the identity of the resource owner of the LUN on which the cache metadata resides from a cluster management device or module.

If the current server node 200 is not the resource owner of the LUN (608), it may proceed to operate in a pass-through mode (610). For example, if the server node 200 is not the owner of the cache metadata or the owner of the LUN on which the cache metadata resides, it may have no authority to access and/or modify the cache metadata stored in the cache metadata partition 262 of the data store 260. Thus, the current server node 200 may continue to passively monitor cache metadata (e.g., until the current owner of the cache metadata fails or is deregistered as the owner).

If the current server node 200 is the resource owner of the LUN (608), it may subsequently force a takeover of the cache metadata (609). For example, the server node 200 may be authorized to modify (e.g., read from and/or write to) the LUN on which the cache metadata partition 262 is formed, even if it is not the owner of the actual cache metadata stored on the LUN. Moreover, as the resource owner of the LUN, the server node 200 may have the authority to override the ownership of any data stored on the LUN. Thus, upon determining that the current serve node 200 is the resource owner of the LUN on which the cache metadata resides, the registration sub-module 222 may send a forced takeover message instructing the data store 260 that the server node 200 is to become the new owner of the cache metadata stored in the cache metadata partition 262. After forcefully taking over ownership of the cache metadata (609), the server node 200 may proceed to warm up its local cache memory (605).

It should be noted that, while the systems and methods described above (e.g., with respect to FIGS. 1-6) are particularly well-suited for quickly warming up a cache memory in the event of a node failover, various other use cases are also contemplated. For example, the systems and methods herein may be useful for retrieving warmed-up cache data after replacing servers and/or cache memories in a data storage system.

The systems and methods herein may also be used to preload a cache memory to match a particular application workload pattern. For example, some application workloads may follow a certain pattern that is repeated over a given time period (e.g., a day or a week). By taking snapshots of the cache metadata at particular time periods, those snapshots may then be used to preload the cache memory based on the application workload pattern.

Further, the systems and methods herein may be used to speed up the performance of job-specific applications. For example, certain applications are scheduled to regularly perform routing jobs (e.g., daily report, weekly, report, daily data processing, data export, etc.). By taking snapshots of the cache metadata associated with each task, the working data set for a given application can be preloaded to cache memory prior to the task being performed.

Still further, the systems and methods herein may be useful in data mining, analysis, and modeling applications. For example, a system administrator may take a snapshot of the cache metadata on a host server and analyze and/or mine the data associated with that cache metadata, concurrently, on another server without interrupting the data access requests being serviced by the host server.

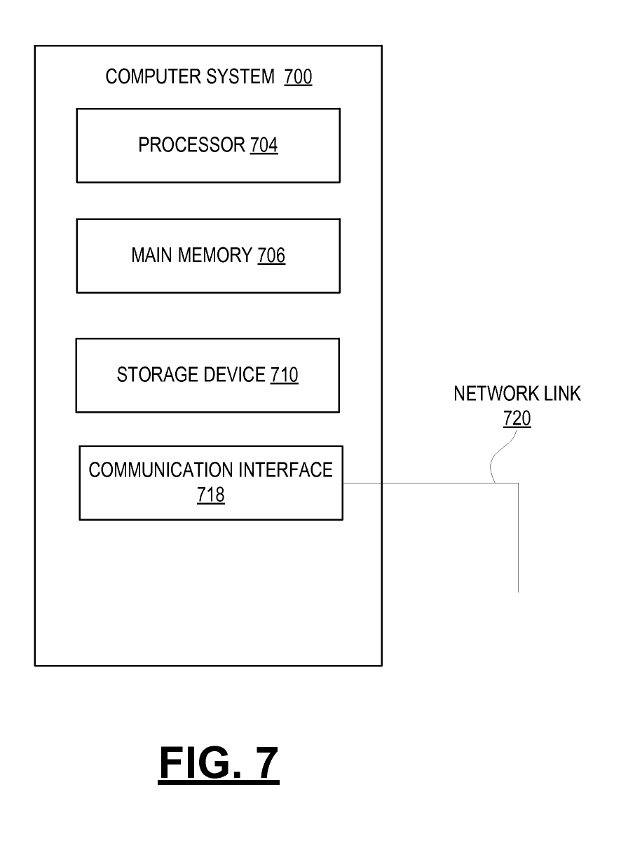

FIG. 7 is a block diagram that illustrates a computer system upon which aspects described herein may be implemented. For example, in the context of FIG. 2, the server node 200 may be implemented using one or more computer systems such as described by FIG. 7. Still further, methods such as described with FIGS. 3-6 can also be implemented using a computer such as described with an example of FIG. 7.

In an aspect, computer system 700 includes processor 704, memory 706 (including non-transitory memory), storage device 710, and communication interface 718. Computer system 700 includes at least one processor 704 for processing information. Computer system 700 also includes a main memory 706, such as a random access memory (RAM) or other dynamic storage device, for storing information and instructions to be executed by processor 704. Main memory 706 also may be used for storing temporary variables or other intermediate information during execution of instructions to be executed by processor 704. Computer system 700 may also include a read only memory (ROM) or other static storage device for storing static information and instructions for processor 704. A storage device 710, such as a magnetic disk or optical disk, is provided for storing information and instructions. The communication interface 718 may enable the computer system 700 to communicate with one or more networks through use of the network link 720 (wireless or wireline).

In one implementation, memory 706 may store instructions for implementing functionality such as described with an example of FIGS. 1A-1B and 2, or implemented through an example method such as described with FIGS. 3-6. Likewise, the processor 704 may execute the instructions in providing functionality as described with FIGS. 1A-1B and 2 or performing operations as described with an example method of FIGS. 3-6.

Aspects described herein are related to the use of computer system 700 for implementing the techniques described herein. According to one aspect, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific aspects and details are encompassed by this disclosure. It is intended that the scope of aspects described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. A method of storing data, the method comprising:
retrieving a first set of metadata associated with data stored on a first cache memory;
storing the first set of metadata on a primary storage device, wherein the primary storage device is a backing store for the data stored on the first cache memory; and
selectively copying data from the primary storage device to a second cache memory based, at least in part, on the first set of metadata stored on the primary storage device.

2. The method of claim 1, wherein selectively copying data from the primary storage device to the second cache memory comprises:
determining that the first cache memory is in a failover state; and
copying the data from the primary storage device to the second cache memory upon determining that the first cache memory is in the failover state.

3. The method of claim 1, further comprising:
retrieving a second set of metadata associated with the data stored on the first cache memory; and
storing the second set of metadata on the primary storage device.

4. The method of claim 3, wherein the first set of metadata corresponds with a first application state of the data stored on the first cache memory, and wherein the second set of metadata corresponds with a second application state of the data stored on the first cache memory.

5. The method of claim 3, further comprising:
assigning a first label to the first set of metadata based, at least in part, on a time at which the first set of metadata is retrieved from the first cache memory; and
assigning a second label to the second set of metadata based, at least in part, on a time at which the second set of metadata is retrieved from the first cache memory.

6. The method of claim 5, wherein selectively copying data from the primary storage device to the second cache memory comprises:
selecting one of the first or second sets of metadata based on the first and second labels; and
copying data associated with the selected set of metadata from the primary storage device to the second cache memory.

7. The method of claim 1, further comprising:
determining one or more temperature values for the first set of metadata, wherein the one or more temperature values correspond with a number of cache hits for the data associated with the first set of metadata; and
storing the temperature value with the first set of metadata on the primary storage device.

8. The method of claim 7, wherein selectively copying data from the primary storage device to the second cache memory comprises:
copying the data from the primary storage device to the second cache memory based, at least in part, on the one or more temperature values associated with the first set of metadata.

9. A data storage system comprising:
a memory containing machine readable medium comprising machine executable code having stored thereon;
a processing module, coupled to the memory, to execute the machine executable code to:
retrieve a first set of metadata associated with data stored on a first cache memory;
store the first set of metadata on a primary storage device, wherein the primary storage device is a backing store for the data stored on the first cache memory; and
selectively copy data from the primary storage device to a second cache memory based, at least in part, on the first set of metadata stored on the primary storage device.

10. The system of claim 9, wherein the processing module is to copy the data from the primary storage device to the second cache memory by:
determining that the first cache memory is in a failover state; and
copying the data from the primary storage device to the second cache memory upon determining that the first cache memory is in the failover state.

11. The system of claim 9, wherein the processing module is to further:
retrieve a second set of metadata associated with the data stored on the first cache memory; and
store the second set of metadata on the primary storage device;
wherein the first set of metadata corresponds with a first application state of the data stored on the first cache memory, and wherein the second set of metadata corresponds with a second application state of the data stored on the first cache memory.

12. The system of claim 11, wherein the processing module is to copy data from the primary storage device to the second cache memory by:
assigning a first label to the first set of metadata based, at least in part, on a time at which the first set of metadata is retrieved from the first cache memory
assigning a second label to the second set of metadata based, at least in part, on a time at which the second set of metadata is retrieved from the first cache memory;
selecting one of the first or second sets of metadata based on the first and second labels; and
copying data associated with the selected set of metadata from the primary storage device to the second cache memory.

13. The system of claim 9, wherein the processing module is to further:
determine one or more temperature values for the first set of metadata, wherein the one or more temperature values correspond with a number of cache hits for the data associated with the first set of metadata; and
store the one or more temperature values with the first set of metadata on the primary storage device.

14. The system of claim 14, wherein the processing module is to copy data from the primary storage device to the second cache memory by:
copying the data from the primary storage device to the second cache memory based, at least in part, on the one or more temperature values associated with the first set of metadata.

15. A computer-readable medium for implementing data storage, the computer-readable medium storing instructions that, when executed by one or more processors, cause the one or more processors to perform operations comprising:
retrieving a first set of metadata associated with data stored on a first cache memory;
storing the first set of metadata on a primary storage device, wherein the primary storage device is a backing store for the data stored on the first cache memory; and
selectively copying data from the primary storage device to a second cache memory based, at least in part, on the first set of metadata stored on the primary storage device.

16. The computer-readable medium of claim 15, wherein the instructions for selectively copying data from the primary storage device to the second cache memory include instructions for:
determining that the first cache memory is in a failover state; and
copying the data from the primary storage device to the second cache memory upon determining that the first cache memory is in the failover state.

17. The computer-readable medium of claim 15, further comprising instructions that cause the one or more processors to perform operations that include:
retrieving a second set of metadata associated with the data stored on the first cache memory; and
storing the second set of metadata on the primary storage device;
wherein the first set of metadata corresponds with a first application state of the data stored on the first cache memory, and wherein the second set of metadata corresponds with a second application state of the data stored on the first cache memory

18. The computer-readable medium of claim 15, wherein the instructions for selectively copying data from the primary storage device to the second cache memory include instructions for:
assigning a first label to the first set of metadata based, at least in part, on a time at which the first set of metadata is retrieved from the first cache memory
assigning a second label to the second set of metadata based, at least in part, on a time at which the second set of metadata is retrieved from the first cache memory;
selecting one of the first or second sets of metadata based on the first and second labels; and
copying data associated with the selected set of metadata from the primary storage device to the second cache memory.

19. The computer-readable medium of claim 15, further comprising instructions that cause the one or more processors to perform operations that include:
determining one or more temperature values for the first set of metadata, wherein the one or more temperature values correspond with a number of cache hits for the data associated with the first set of metadata; and
storing the one or more temperature values with the first set of metadata on the primary storage device.

20. The computer-readable medium of claim 19, wherein the instructions for selectively copying data from the primary storage device to the second cache memory include instructions for:
copying the data from the primary storage device to the second cache memory based, at least in part, on the one or more temperature values associated with the first set of metadata.
